(19) United States
(12) Patent Application Publication
(10) Pub. No.: US 2002/0072987 A1
(43) Pub. Date: Jun. 13, 2002

(54) Methods and systems for business-to-business sourcing services

(76) Inventors: Chris Knudsen, San Diego, CA (US); David G. Rohlander, Orange, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/894,910

(22) Filed: Jun. 28, 2001

Related U.S. Application Data
(60) Provisional application No. 60/214,857, filed on Jun. 28, 2000.

(51) Int. Cl. G06F 17/60

(52) U.S. Cl. 705/26

(57) ABSTRACT

Methods and systems for providing automated interactive marketing systems that enable buyers to be connected to sellers meeting the requirements of the buyers and sellers to be connected with buyers whose needs match the sellers' capabilities.

This application claims the benefit of U.S. Provisional Application No. 60/214,857 filed Jun. 28, 2000 entitled “Method and Systems for Business-to-Business Sourcing Services.”

### FIELD OF THE INVENTION

The preferred embodiments of this invention relate to methods and systems for worldwide sourcing services and facilitating transactions for business-to-business commerce.

### SUMMARY OF THE INVENTION

The preferred embodiments of the invention utilize the worldwide web to provide automated interactive marketing systems that enable immediate access to Sellers worldwide that meet a Buyer's requirements. Buyers are connected with Supplier-Sellers from all around the world who can meet the precise requirements of the Buyer. Sellers are connected with Buyers from all around the world whose needs precisely match the Seller's capabilities.

A significant feature of the preferred embodiments of the invention is that the Buyer needs only to enter a request for quote (RFQ) and the systems and methods of this invention automatically connect the Buyer to Sellers having the capability to produce the item specified in the RFQ. The result is efficient and effective sourcing throughout the world.

### BRIEF DESCRIPTION OF THE DRAWINGS

FIG. 1 illustrates the global coverage provided by the preferred embodiments of the invention for Buyers.

FIG. 2 illustrates the global coverage provided by the preferred embodiments of the invention for Sellers.

FIG. 3 is an overall block diagram illustrating the manner in which multiple databases provide a Unique Community Identifier (UCI) for each Buyer and Seller.

FIG. 4a is an overall flowchart from the Buyer's side.

FIG. 4b is an overall flowchart from the Seller's side.

FIG. 5 is a flowchart illustrating the comparison of the Seller's UCI with RFQs stored in the RFQ database.

FIG. 6 illustrates the data included in the UCI-Company Metrics-General database;

FIG. 7 is an illustrative example of a flow chart for UCI-Company Metrics-Member Capability Edits;

FIG. 8 illustrates the data collected and stored for UCI-Company Default Settings;

FIG. 9 illustrates the data collected and stored for the UCI-Company Default Settings-Supplier Selection-Preferred Vendor List;

FIGS. 10a and 10b illustrate the data collected and stored for the UCI-Company Default Settings-Supplier Selection-Exclude Vendor List;

FIG. 11 illustrates the data collected and stored for UCI-Personal User Metrics-General;

FIG. 12 illustrates the data collected and stored for UCI-Personal User Metrics-New Member Training;

FIG. 13 illustrates the data collected and stored for UCI-Personal User Metrics-New Member Testing;

FIG. 14 illustrates the data collected and stored for UCI-Personal User Metrics-Proprietary Rating System-Buyer;

FIG. 15 illustrates the data collected and stored for UCI-Personal User Metrics-Proprietary Rating System-Seller;

FIG. 16 illustrates the data gathered and stored for UCI-Personal User Metrics-User “Best Value” Criteria;

FIGS. 17a and 17b illustrate the data gathered and stored for the UCI-Personal User Metrics-Supplier Selection-Preferred Vendor List;

FIG. 18 illustrates the data collected and stored for the UCI-Personal User Metrics-Supplier Selection-Exclude Vendor List;

FIG. 19 illustrates the data collected and stored for UCI-Personal User Metrics-Buyer Basic Purchase Criteria;

FIG. 20 illustrates the data collected and stored for UCI-Personal User Metrics-Member Usage Options;

FIG. 21 illustrates the data collected and stored for UCI-Personal User Metrics-Buyer Default Options for Seller Qualifications;

FIG. 22 illustrates the data collected and stored for UCI-Personal User Metrics-Seller Default Options for Buyer Qualifications;

FIG. 23 illustrates the data collected and stored for UCI-Personal User Metrics-Don't Show Feature;

FIG. 24 illustrates the data collected and stored for UCI-Supervisory Detail;

FIG. 25a illustrates the data collected and stored for UCI-Security Data;

FIG. 25b illustrates the data collected and stored for UCI-Security Data, Company Administration;

FIG. 26 is a flow chart illustrating the user's capability to change profile data easily and effectively;

FIG. 27 is a flow chart illustrating the manner in which company profile data is edited;

FIG. 28 is an exemplary screen shot of an illustrative bid history;

FIG. 29 is an exemplary screen shot of Bid Detail available to Buyers;

FIG. 30 is a flow chart illustrating the manner in which Buyers rate Sellers;

FIG. 31 is a flow chart illustrated this manner in which Sellers rate Buyers;

FIG. 32 is a flow chart illustrating the manner in which the RFQ Historical Database is used by Sellers to locate Buyers of similar components;

FIG. 33 is a flow chart illustrating the manner in which the RFQ Historical Database is used by Sellers to review historical pricing for similar components;

FIG. 34 is a flow chart illustrating the manner in which the RFQ Historical Database is used by Buyers to locate Sellers of similar components;

FIG. 35 is a flow chart illustrating the manner in which the RFQ Historical Database is used by Buyers to review global historical pricing for similar components;

FIGS. 36a and 36b are flow charts illustrating the manner in which a Buyer posts a request for quote (RFQ);

FIG. 37 is a flow chart illustrating the manner in which a photograph of a component is archived;

FIG. 38 is a flow chart illustrating the manner in which part and process descriptions are stored for each component;

FIG. 39 is a flow chart showing the listing of RFQs for Buyers;

FIG. 40 is a flow chart illustrating the listing of available RFQs for Sellers;

FIG. 41 is an exemplary screen shot showing a Seller the open RFQs available for bidding;

FIG. 42 is a flow chart illustrating the notification of bid closure;

FIG. 43 is a chart illustrating the information stored in the member profile;

FIG. 44 is a flow chart illustrating targeted advertising to members meeting specific criteria;

FIG. 45 is a flow chart illustrating the collection of data into a Member Usage History Database;

FIG. 46 is a flow chart illustrating the manner in which certain member data is verified; and

FIG. 47 is a flow chart illustrating membership tracking.

### DETAILED DESCRIPTION OF THE PREFERRED EMBODIMENTS

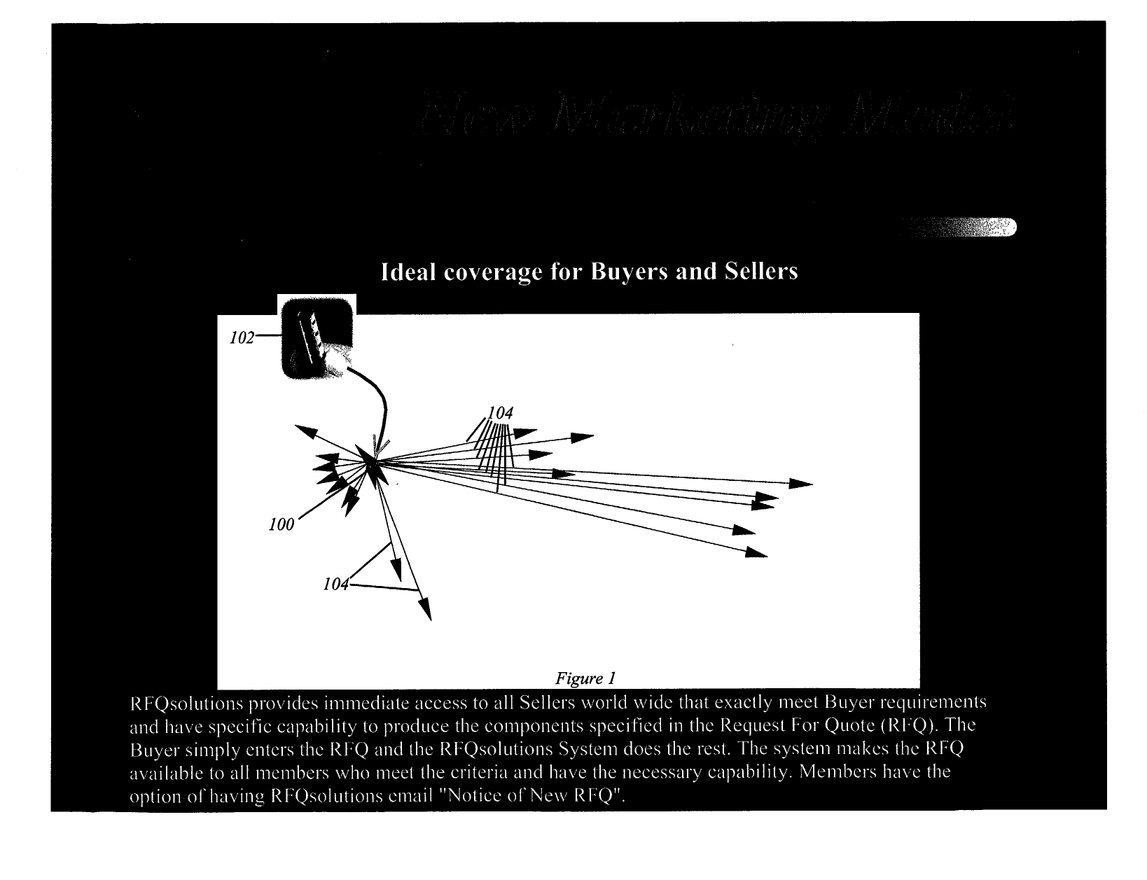

The methods and systems of the preferred embodiments of this invention provide global coverage for both Buyers and Sellers. By way of example, as illustrated in FIG. 1, a single Buyer 100 located in the U.S.A. can instantly send out a request for quote (RFQ) for manufacture of a component 102 all over the world. However, as described below, this RFQ is not “broadcast” to a general group of Sellers. Rather, the arrows 104 are directed only to Sellers having the specific capability to produce component 102. In the preferred embodiments, the member Sellers have the option of having an email “Notice of New RFQ” sent to them each time an RFQ is submitted for which they are a qualified Seller.

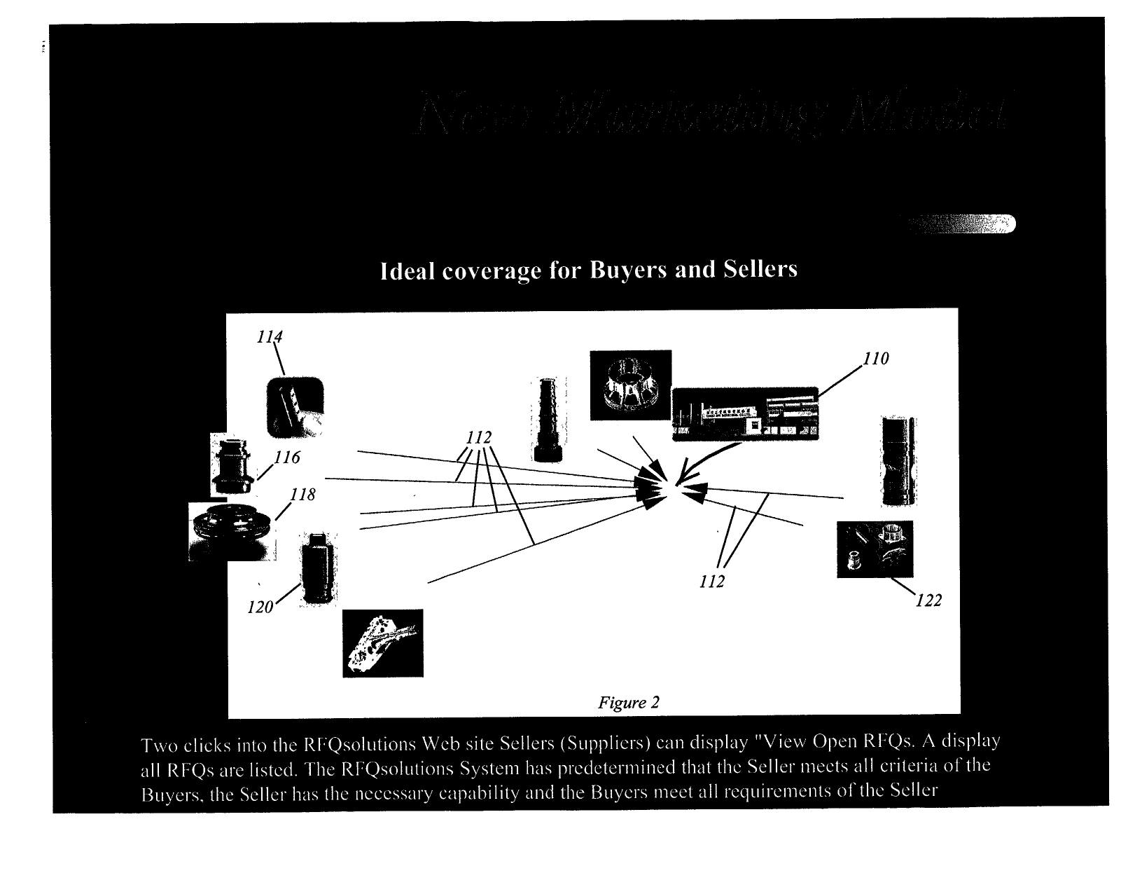

Each member Seller can, by a few clicks (typically two) into the system web site, view open RFQs. As depicted in FIG. 2, a qualified Seller 110 can instantly view all open RFQs that the system has automatically determined that Seller 110 meets all of the particular criteria selected by one or more Buyers (illustrated by arrows 112). As shown, each Buyer 112 has a particular component 114, 116, 118, 120 and 122 for which the respective Buyers are desirous of receiving quotations from qualified Sellers.

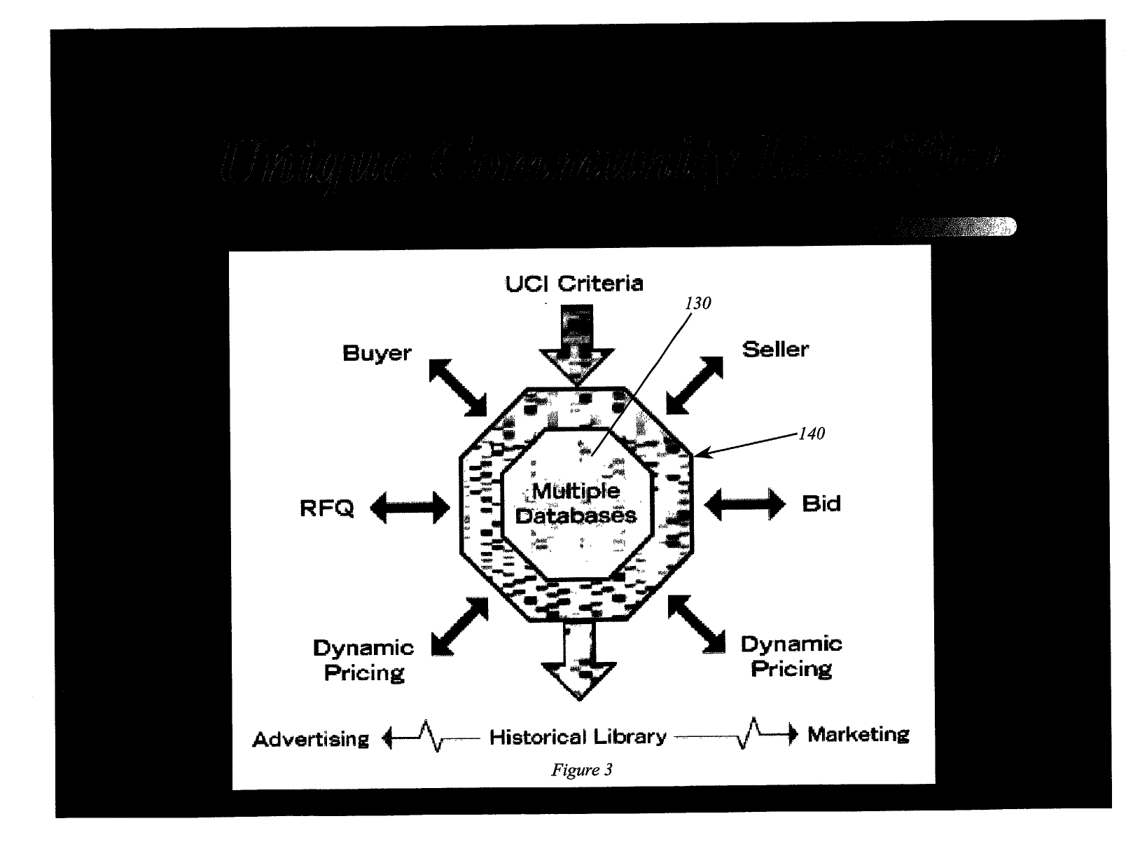

The multiple function provided by the systems and methods of this invention are illustrated in FIG. 3. This figure illustrates the overall block diagram of the system. Multiple databases 130 (described below) store data collected from member Buyers and Sellers. Such data includes: Company Metrics, Company Default Settings, Personal User Metrics, Supervisory Detail, Security Data. Each member's Capabilities and Capacities are defined.

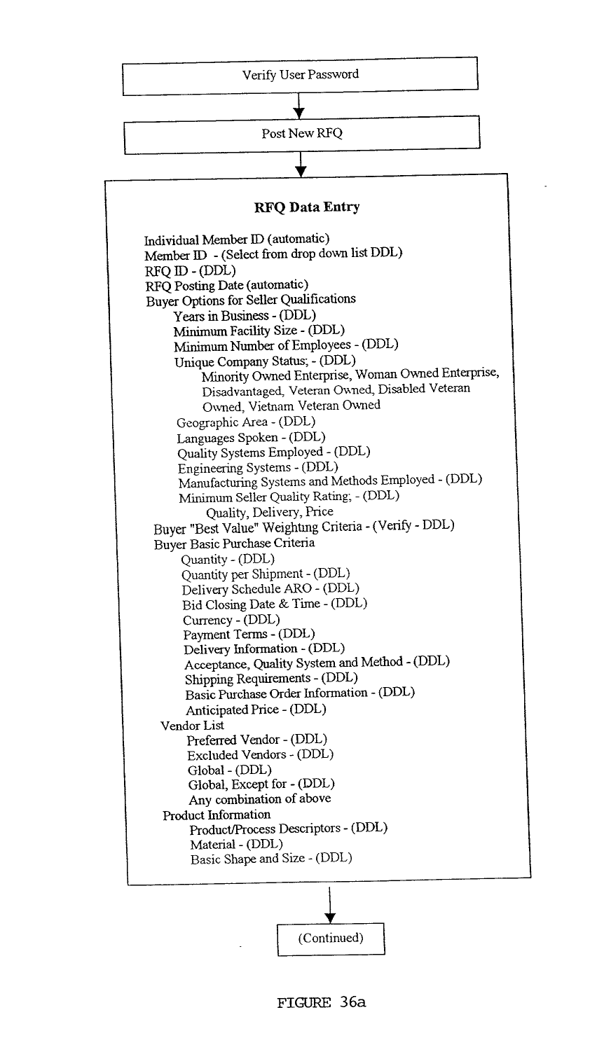

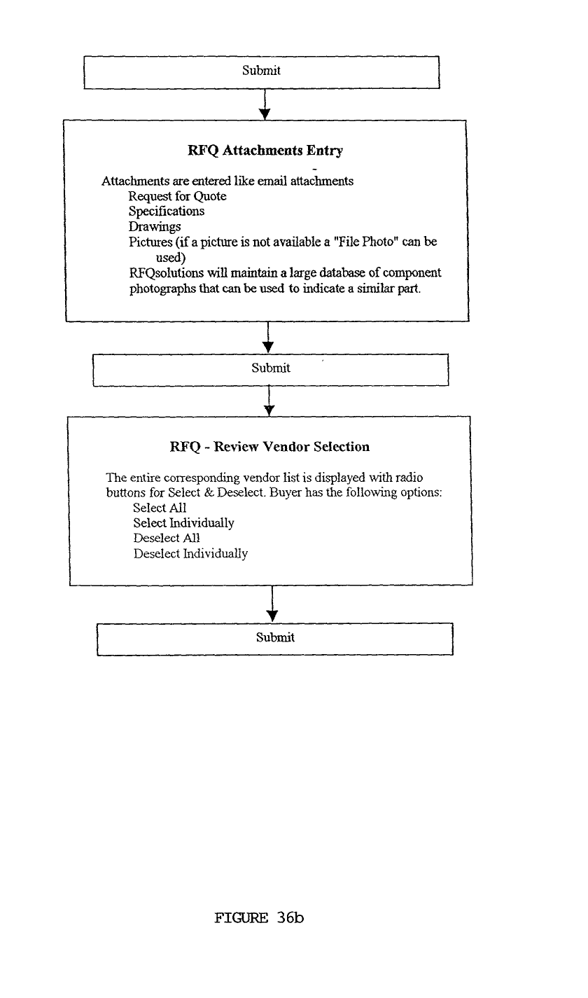

As shown in FIG. 3, Buyers post Request for Quotes (RFQ) to the system web site 140. The RFQ data entry is illustrated in FIGS. 36a and 36b and includes Buyer requirements for the Seller, Contract Specifications, Drawings, Specifications, and Component Photographs. Buyers have the option of using only their Preferred Vendors, a combination of Global Vendors and the Preferred Vendors, or Global Vendors. The system also accommodates the use of a Vendor Exclusion List. Buyers can select Exclude Geographic Areas for potential Sellers.

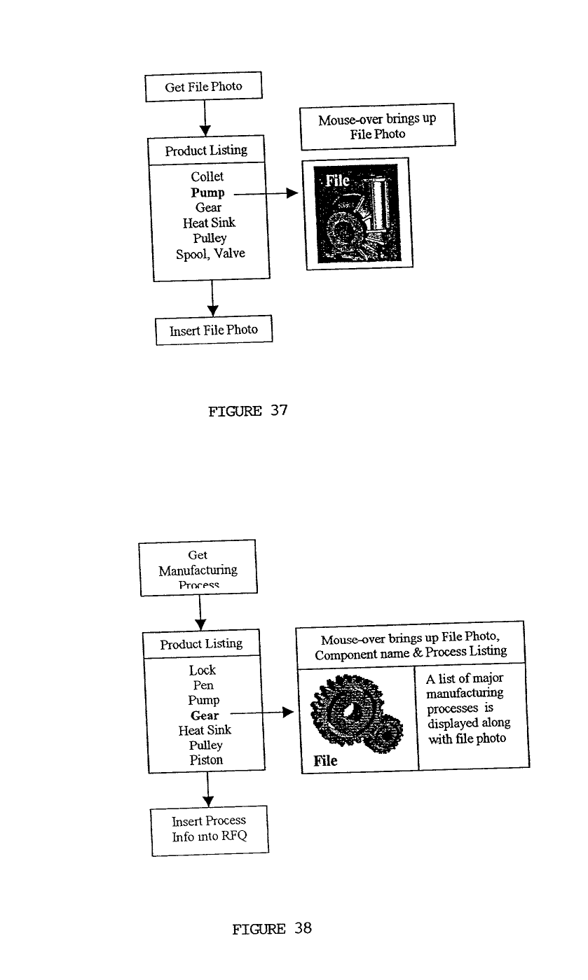

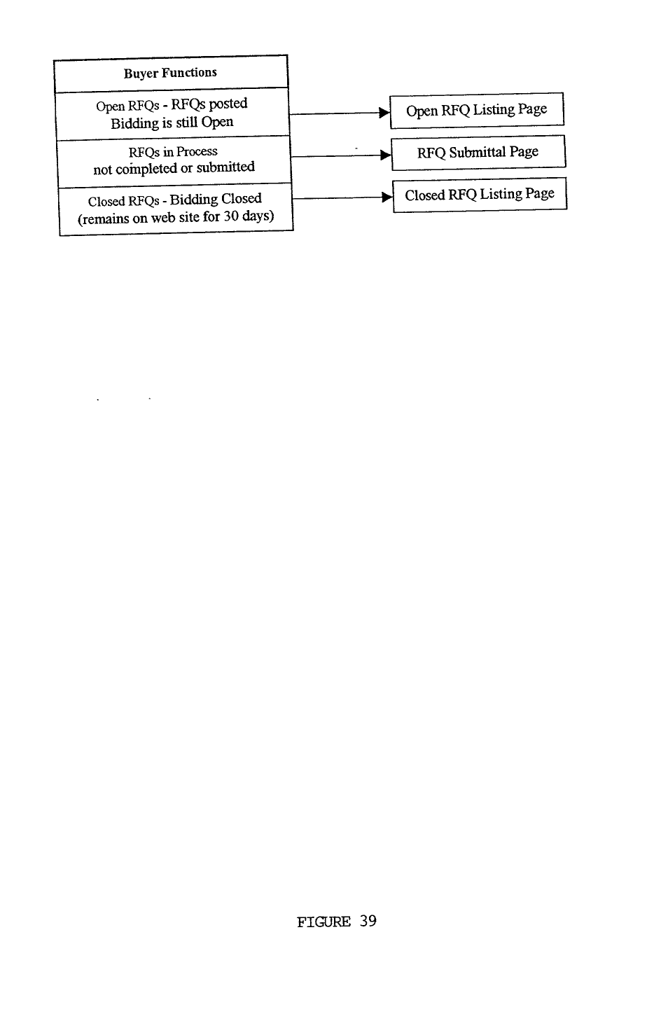

Each RFQ advantageously contains photo(s) of the component listed. See the flow chart of FIG. 37. A “File Photo” can be used if a picture is not available. The system also maintains a large database of component photographs that can be used to indicate a similar part.

A feature of this invention is that it greatly facilitates international sourcing of goods by reducing the confusion inherent in difficult naming conventions. Thus, items such as screws, bolts, fasteners, wood screws, machine screws, carriage bolts are all similar products. This system provides photos with product listings to reduce confusion. As shown in FIG. 38, major manufacturing processes are listed for each component to aid in the manufacturing process description in the RFQ.

The system automatically returns a list of potential Sellers. The Buyer then has the opportunity to Select or Deselect Sellers. Submitting the Supplier List makes the RFQ immediately available to all Selected Sellers.

Sellers can efficiently review the RFQs and make decisions to Quote or not Quote. Sellers can easily view the RFQ, Contract Specifications, Drawings, and Specifications online. Sellers can then download the RFQ, Contract Specifications, Drawings, and Specifications.

Bidding is done online. The Seller has access to competitor pricing via a real time pricing chart. Bids are easily entered. The Bid Process is simple and effective. A Bid calculator is provided on the “Bid Detail” page of the Web site. New bid prices can be directly input or price may be calculated as a percentage above or below the current lowest price. Prices may be changed at any time during the quotation period. A bid may also be canceled at any time.

The Buyer has access to all pricing as well as Seller information. Seller information includes the Seller's Profile, Quality Rating Data, and a link to the Seller's Web Page.

All Bid Data is stored in the RFQsolutions Historical Library. This database facilitates marketing research and targeted advertising and marketing.

The bidding data collected from Buyers and Sellers are discussed in detail below and are advantageously quite detailed such that the criteria collected provides a Unique Community Identifier (UCI) for each Buyer and Seller.

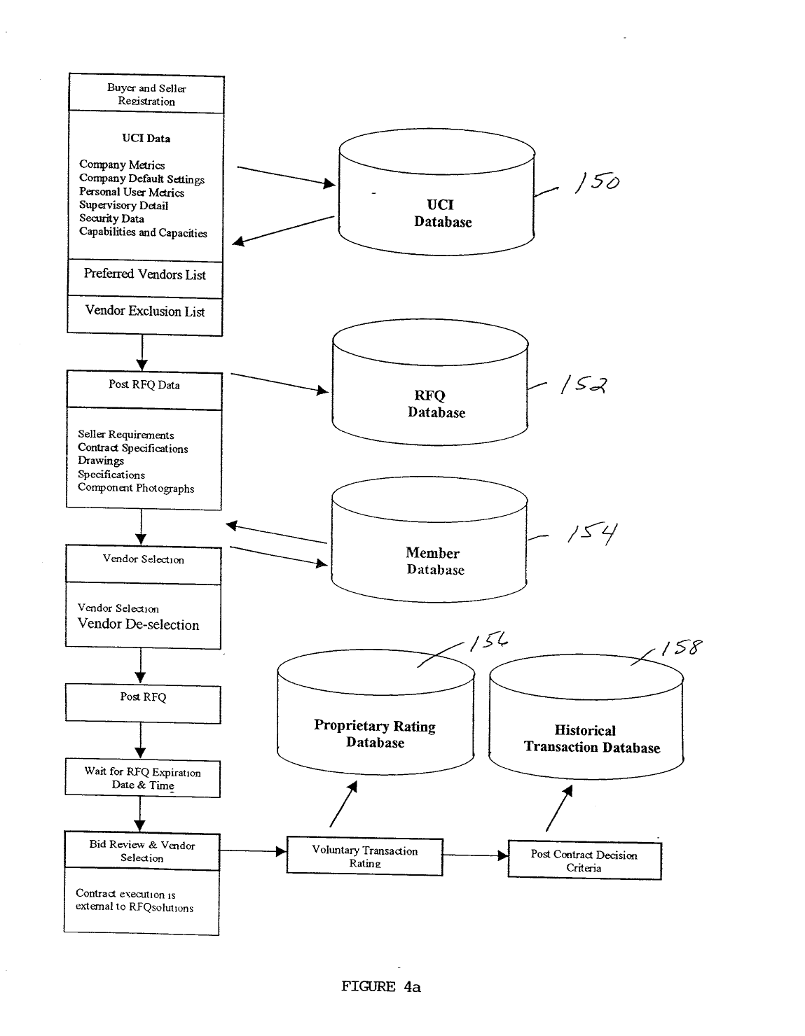

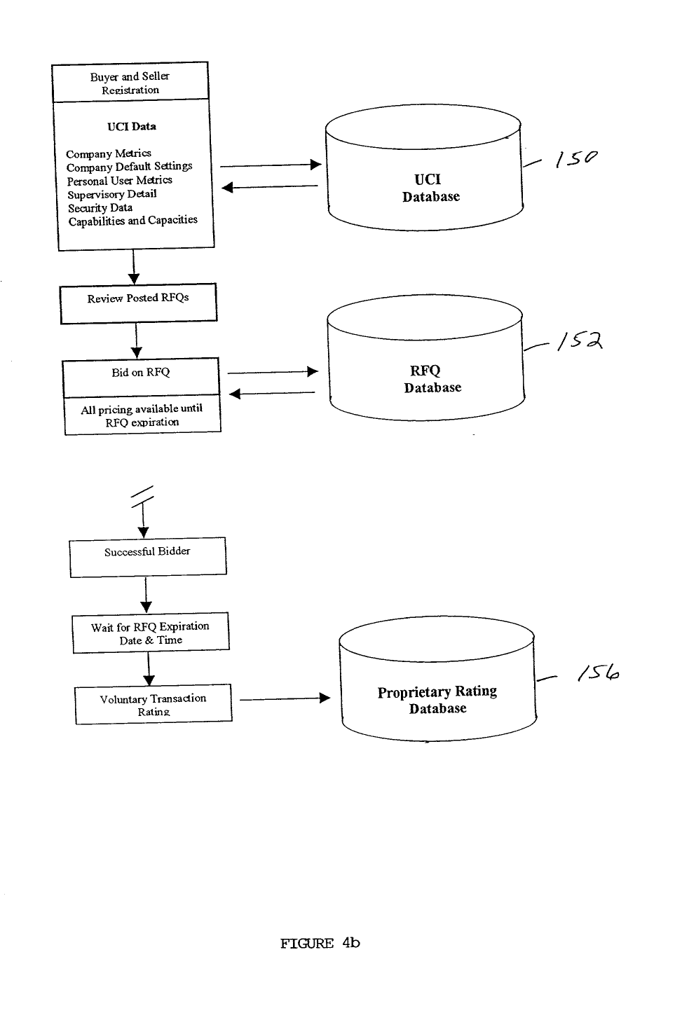

A flowchart depicting the overall operation of the systems and methods of a preferred embodiment of the invention from the Buyer's side is illustrated in FIG. 4a. As illustrated, a plurality of databases store the information for interested qualified Sellers with RFQs posted by Buyers. These databases include a UCI Database 150, RFQ Database 152, Member Database 154, Proprietary Rating Database 156, and Historical Database 158.

A flowchart depicting the overall operation of the systems and methods of a preferred embodiment of the invention from the Seller's side is illustrated in FIG. 4b.

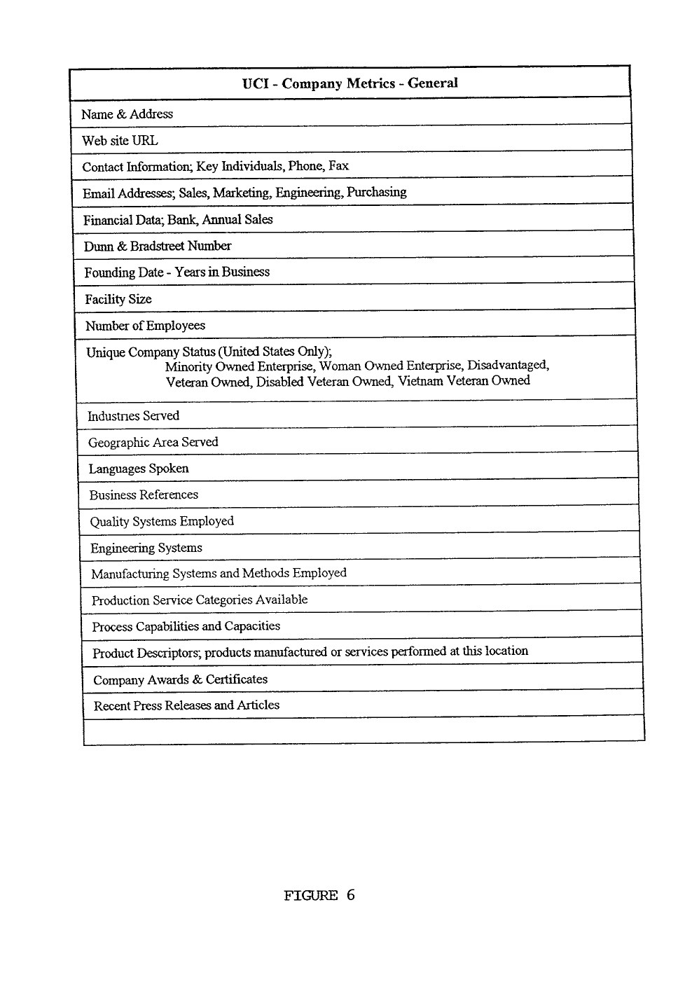

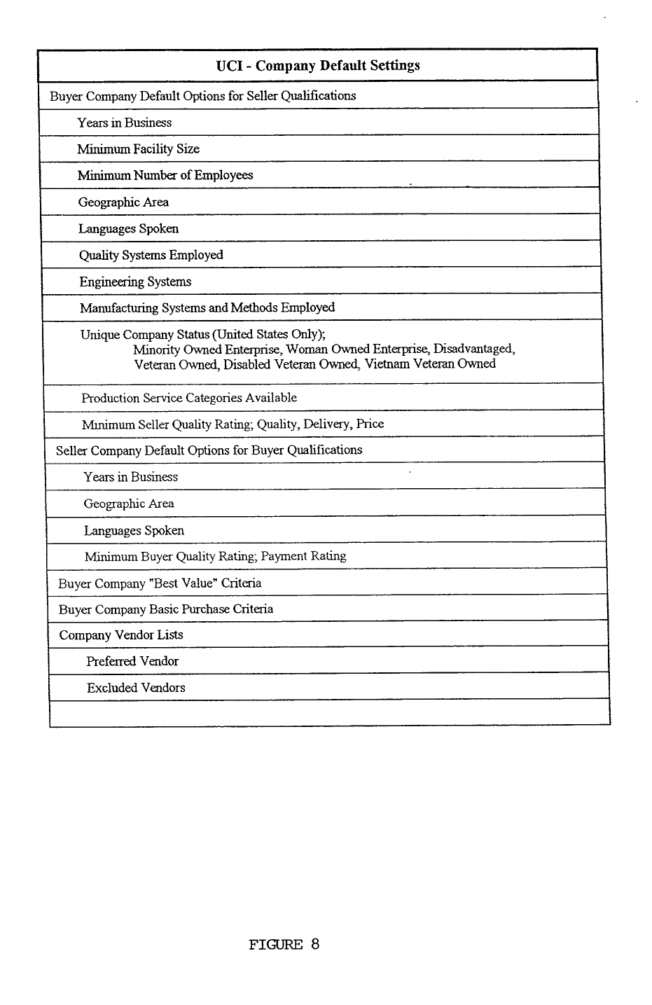

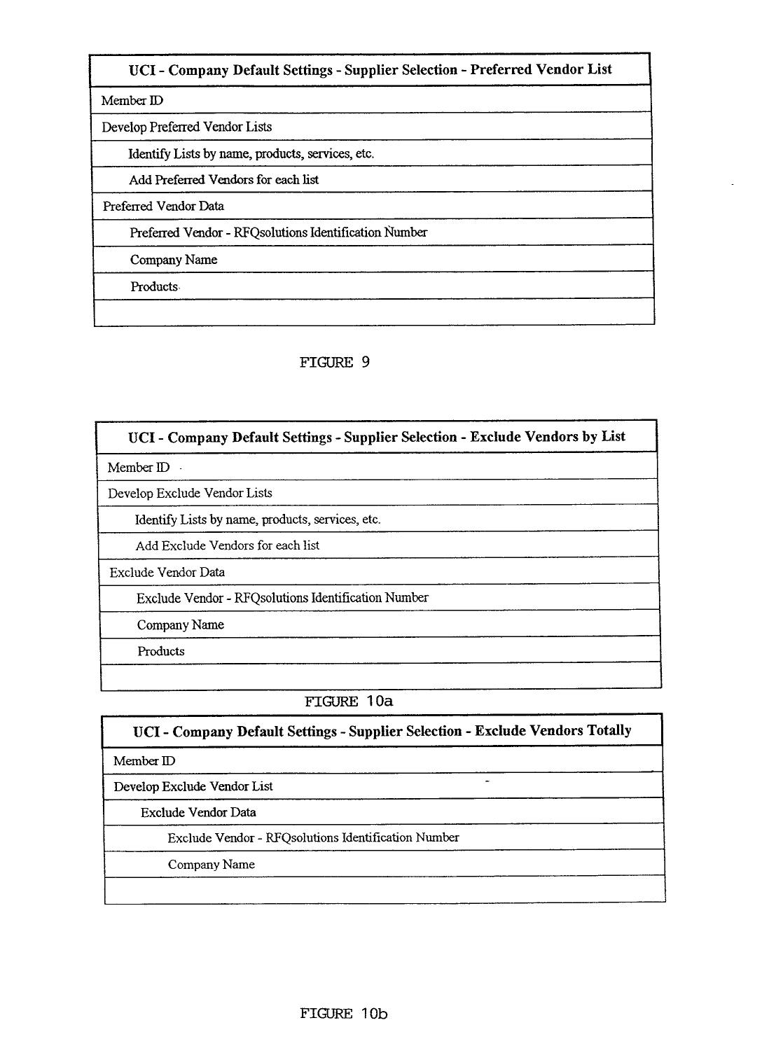

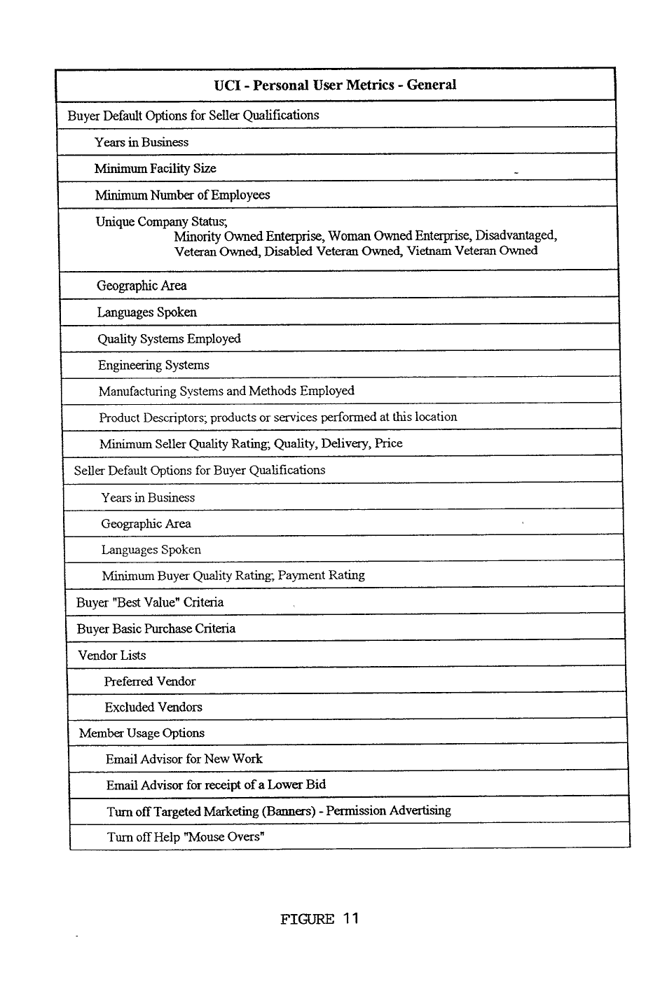

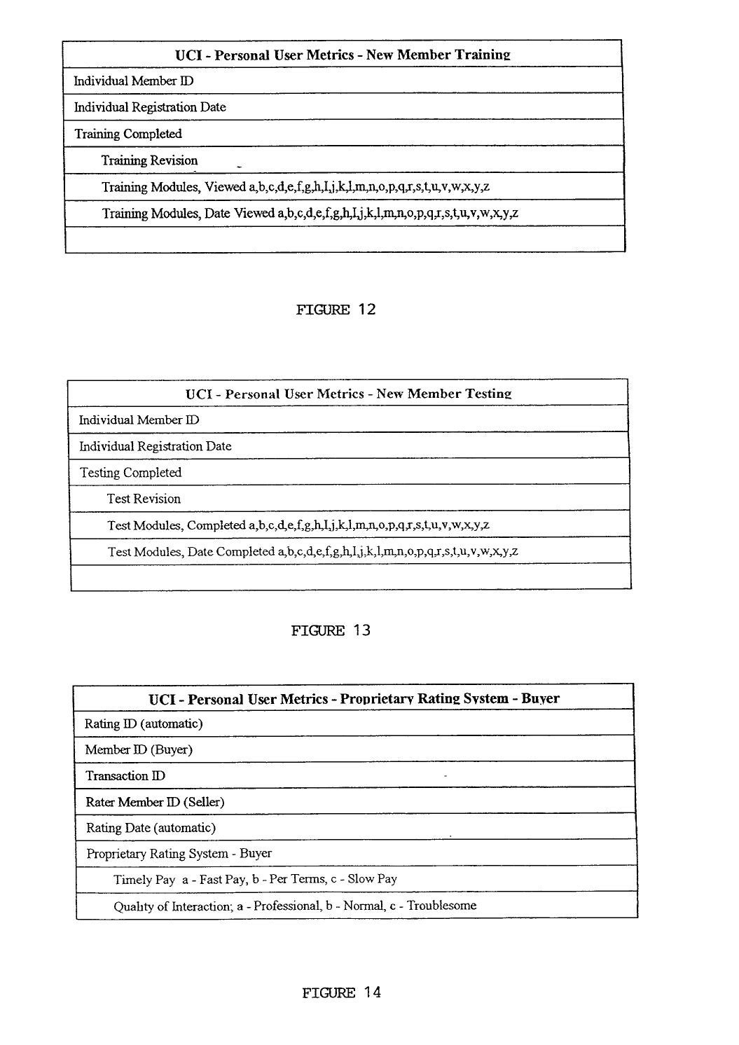

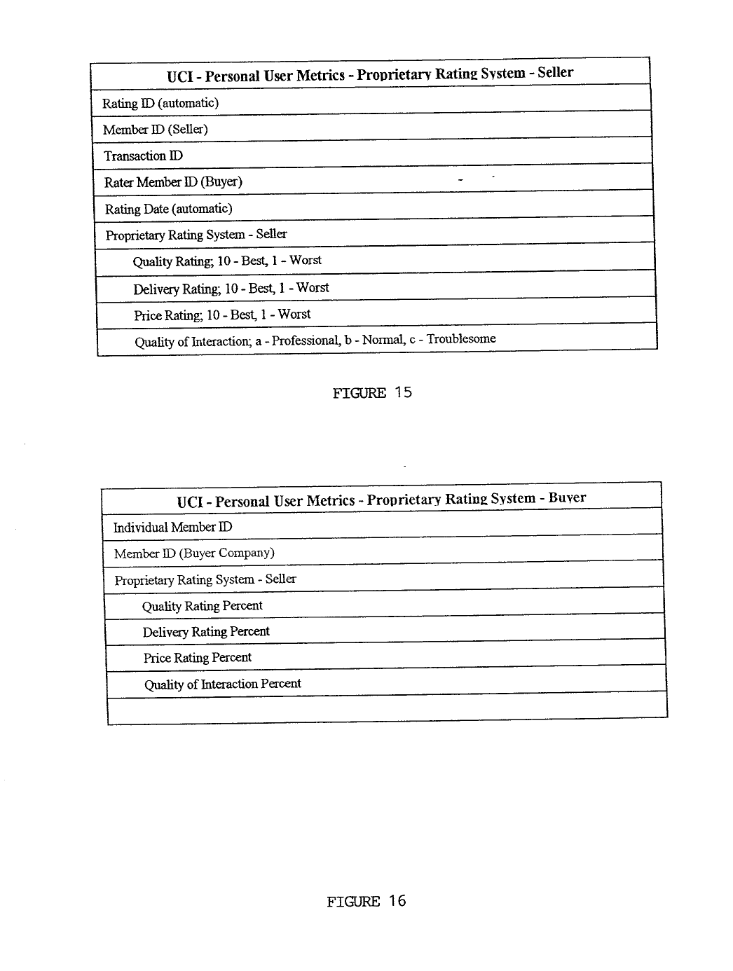

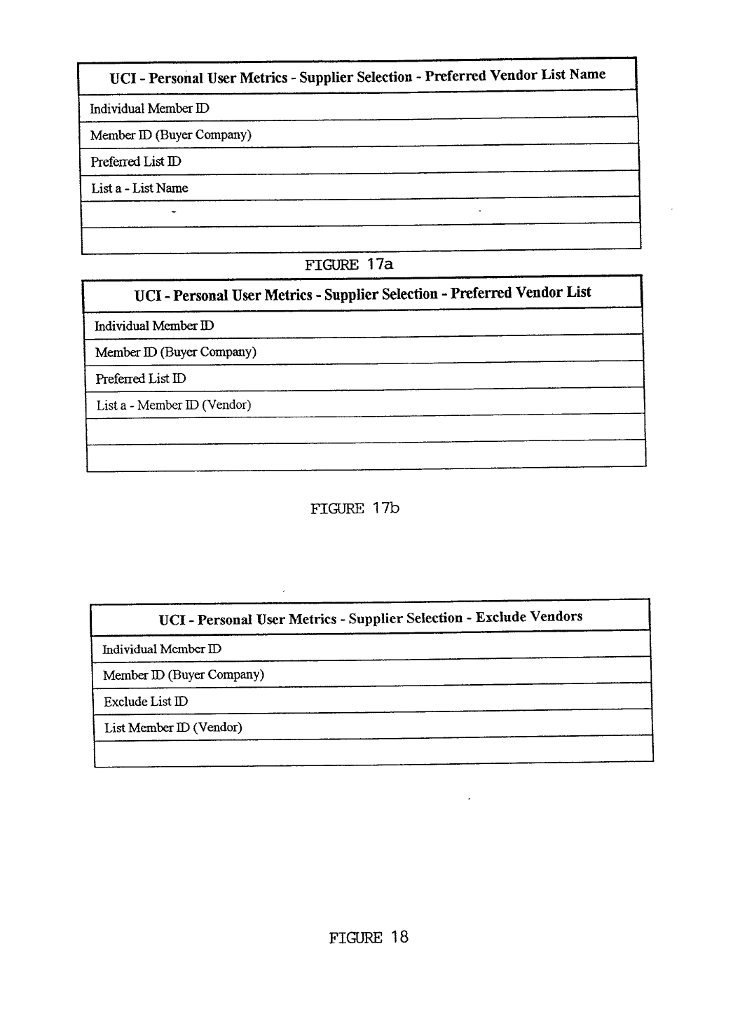

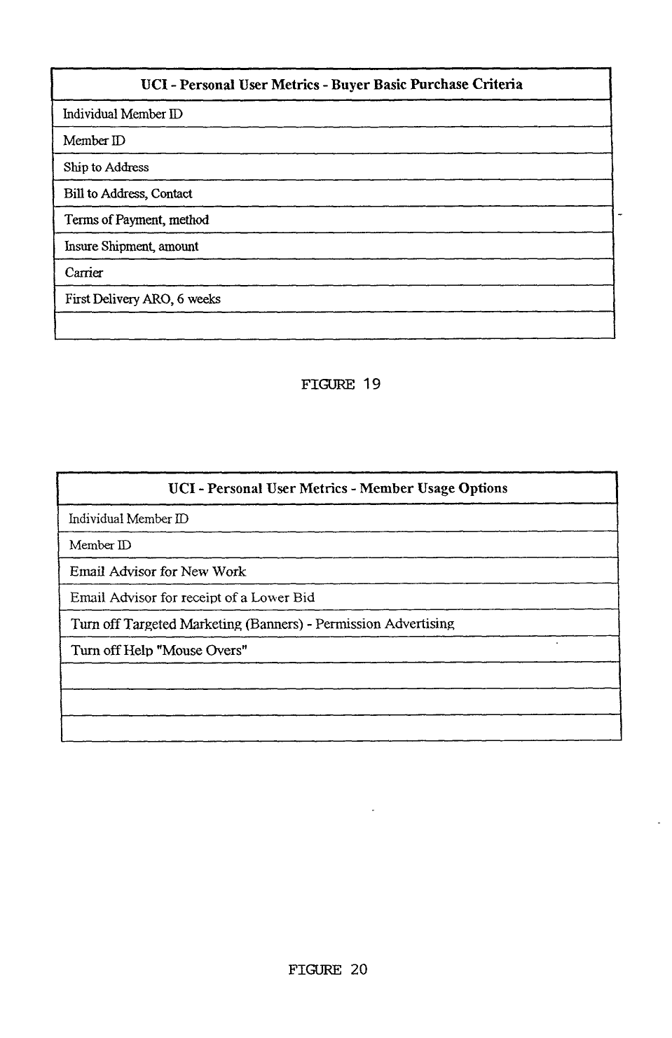

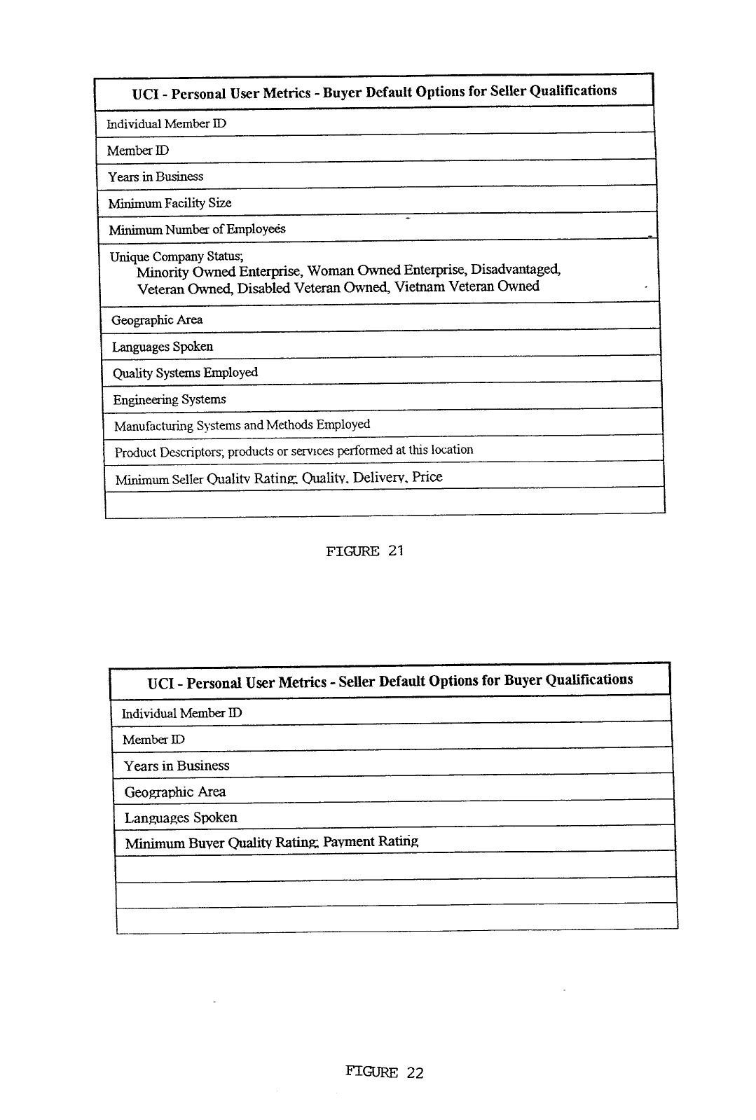

The UCI Database 150 is designed to be a very comprehensive database of manufacturing companies worldwide including their sales volumes, process capabilities and industries and markets served. FIGS. 6, 8, 9, 10a, 10b, 11, 12, 13, 14, 15, 16, 17a, 17b, 18, 19, 20, 21, 22, 23, 24, 25a, 25b, illustrate in detail the data collected in the preferred embodiments of the invention.

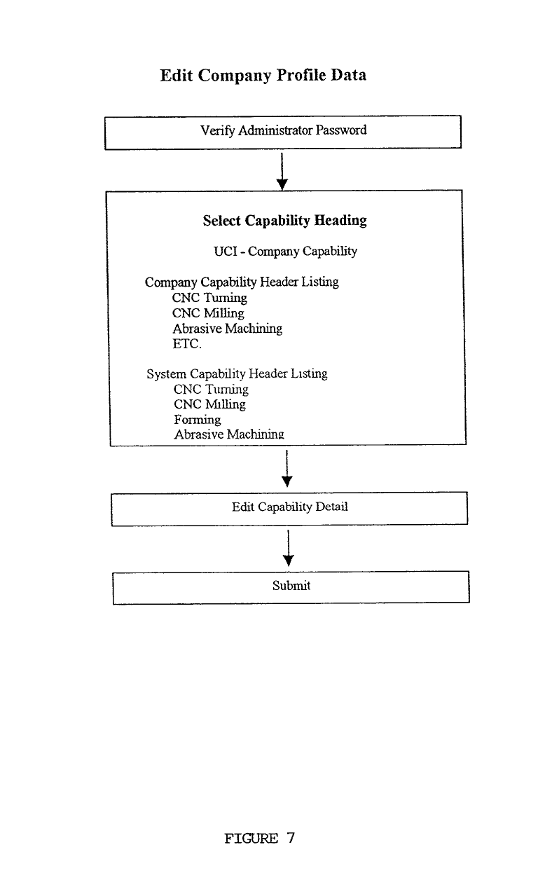

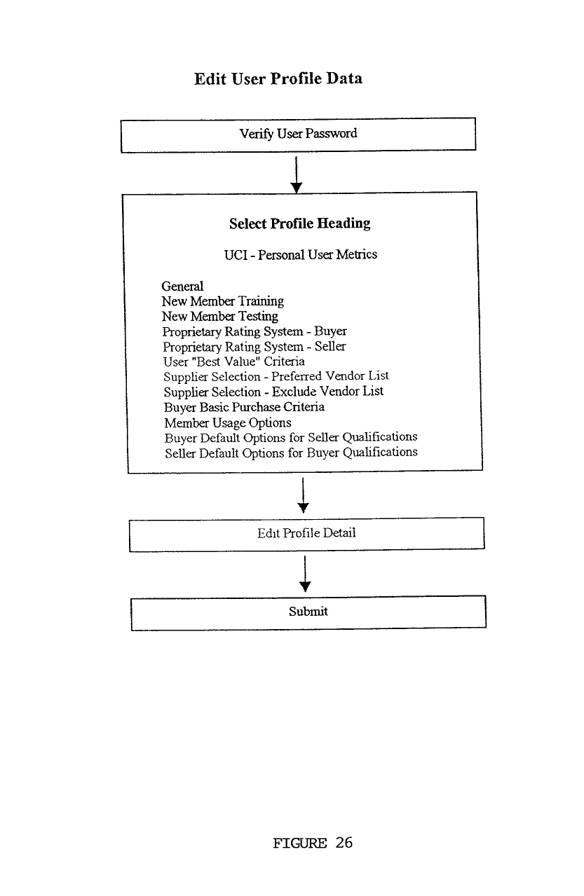

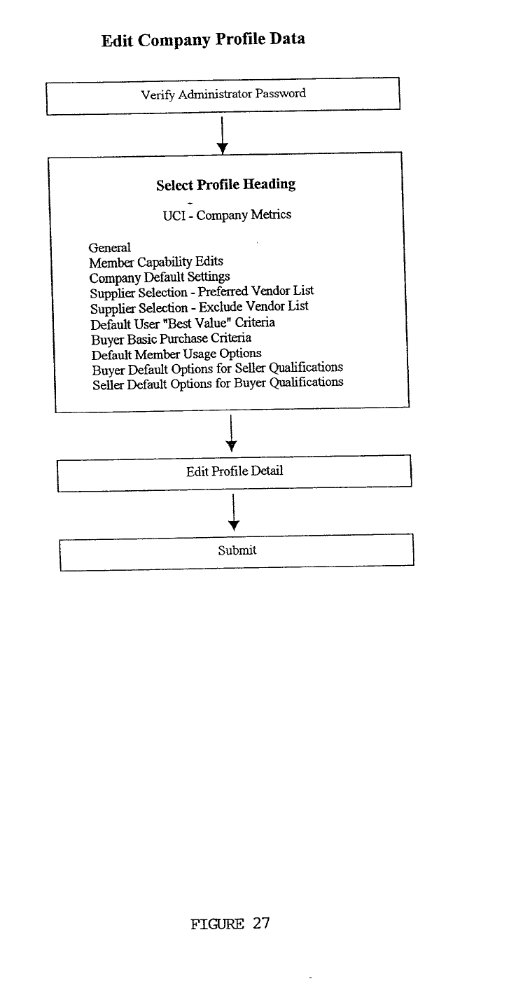

FIGS. 7, 26, 27 are flow charts illustrating editing of the stored data.

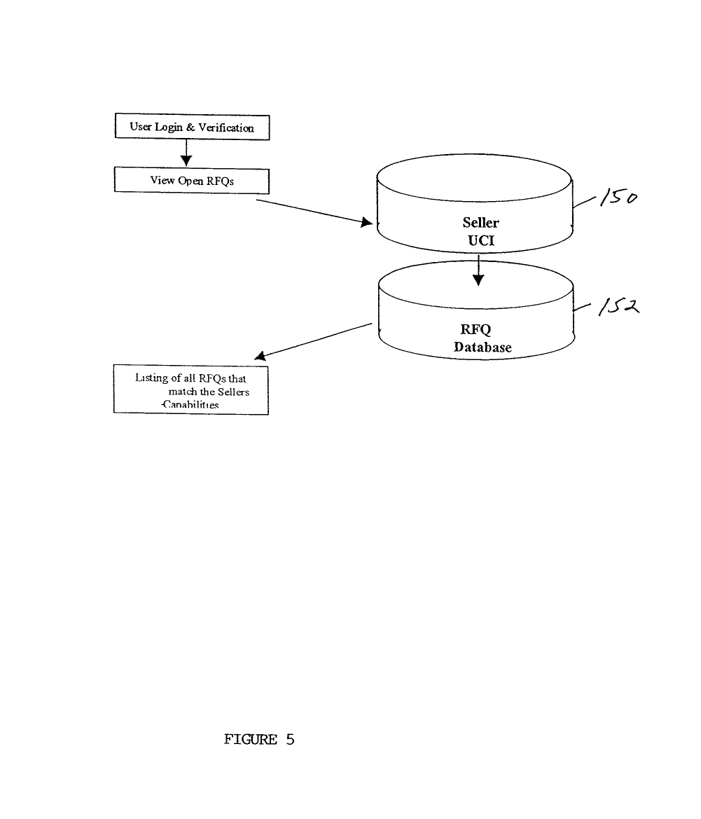

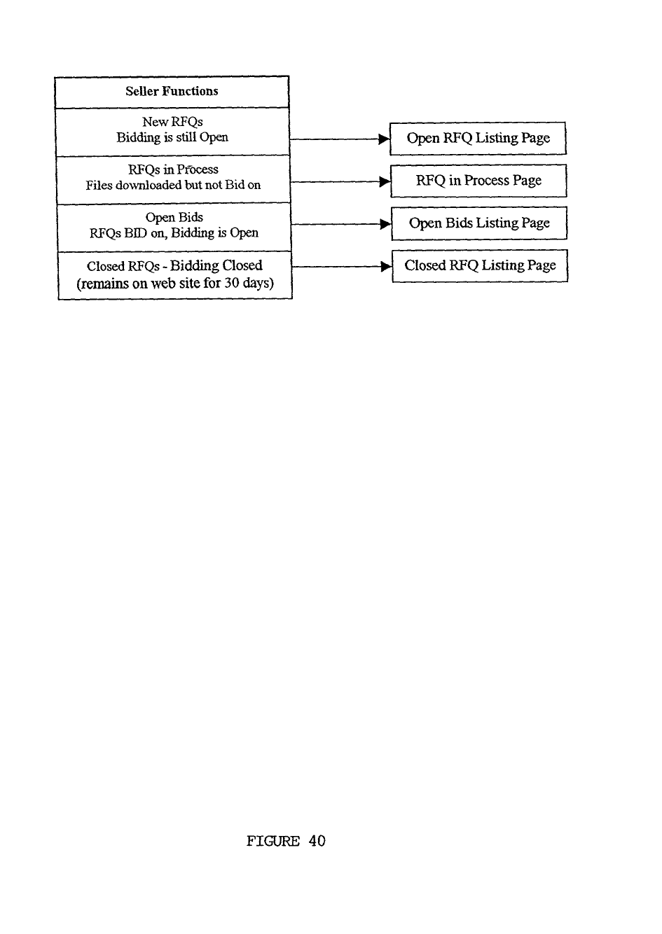

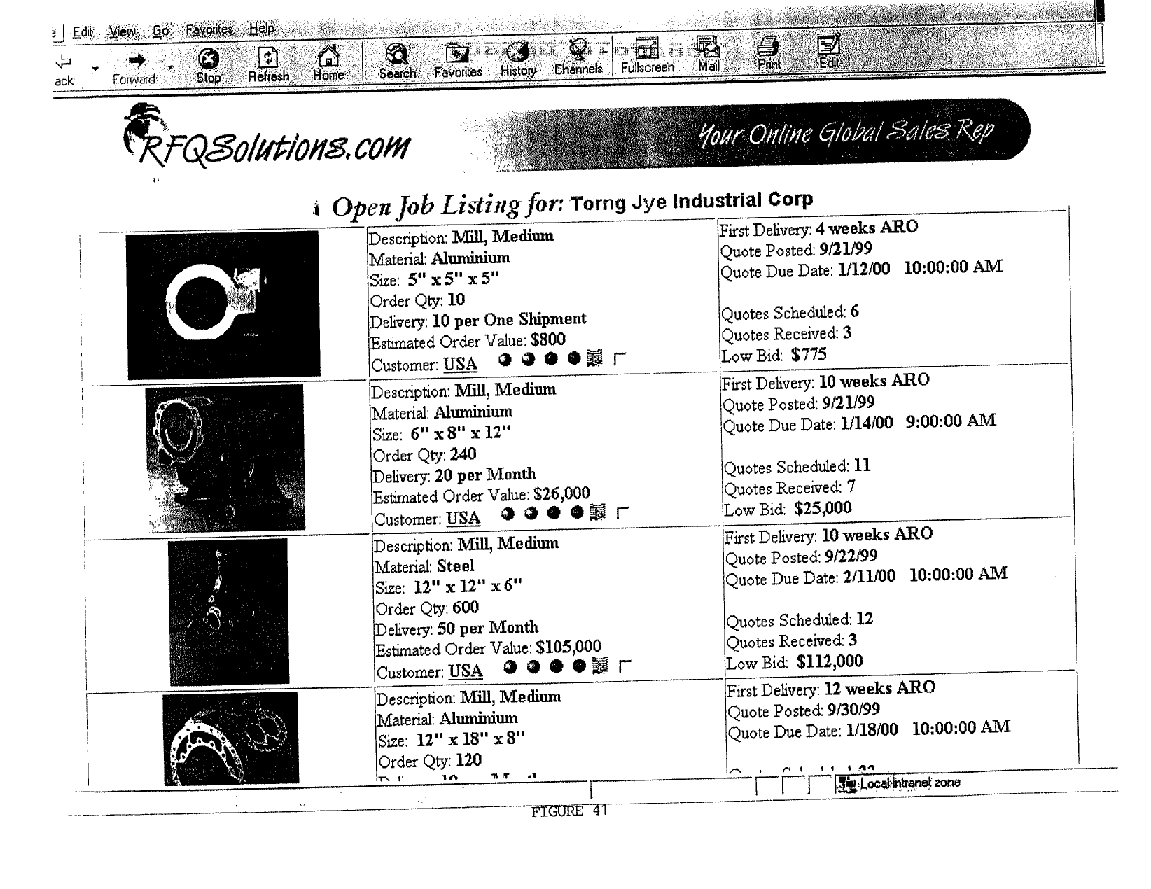

FIG. 5 depicts the manner in which a Seller in the UCI Database 150 is compared with the RFQs stored in the RFQ Database 152 to produce a listing of all RFQs that match the Seller's Capabilities. A flow chart showing the RFQ seller function is illustrated in FIG. 40. A representative screen shot showing the Open Job Listing made available to a qualified Seller, with photographs of the components, is illustrated in FIG. 41. Similar screen shots are made available for the Buyers as illustrated by FIG. 35.

In the preferred embodiments, the Sellers have real time price data available for each RFQ. Advantageously, the dynamic pricing model provides the following information:

Buyers see:

All Pricing in Chart Form

All Seller's complete Profile

All Seller's Quality Ratings

All Seller's Web sites

All tariffs, duties and shipping costs

Past purchases for identical components

Historical transactions for similar components

Seller's see:

All Pricing in Chart Form

Buyer's complete Profile

Buyers Web site

Buyer's Quality Rating

Buyer's “Best Value” Criteria

Links to determine tariffs, duties and shipping costs

Historical transactions for similar components

The Pricing Chart is Updated Dynamically as Bids are received by RFQsolutions

A pricing calculator is provided to aid in pricing calculations

“X” percent higher than lowest bid

“X” percent lower than lowest bid

“X” percent higher than seller's last bid

“X” percent lower than seller's last bid

Direct entry of Price

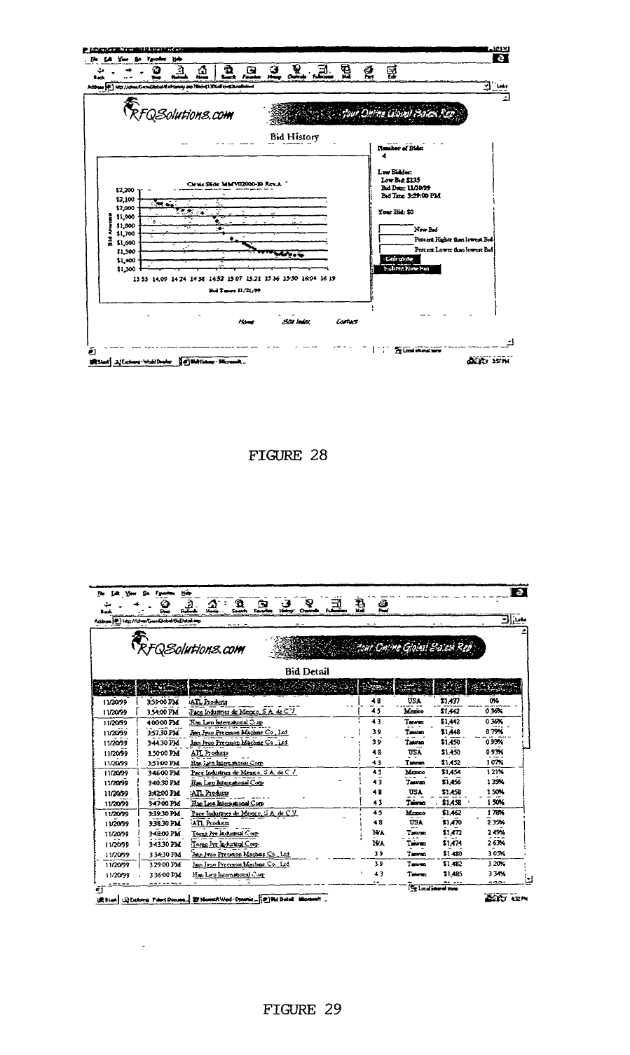

As shown in FIG. 28, all competitor bid prices are shown. Bid prices can easily be entered and can be updated by Sellers right up to the time of Bid Closing. Advantageously, the main system clock is the reference for time worldwide to avoid confusion. Advantageously, a price calculator is provided to make price updates effortless. Prices can be calculated above and below the then lowest bid price. Prices can also be entered directly.

As shown in FIG. 29, Buyers also have real time price data available for each RFQ. Buyers also have real time price data available for each RFQ. Buyers additionally have access to all bid detail. Details for all bids are listed and ranked by a number of parameters including; Price, Best Value, Quality Rating, Delivery Rating, Price Rating and Geographic Location. Links are provided to the Seller Profile and Seller Web site to aid in purchase decisions.

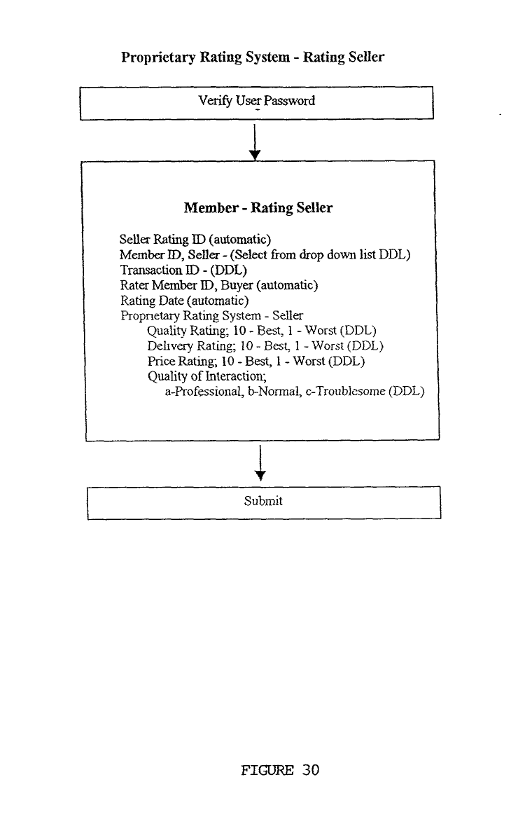

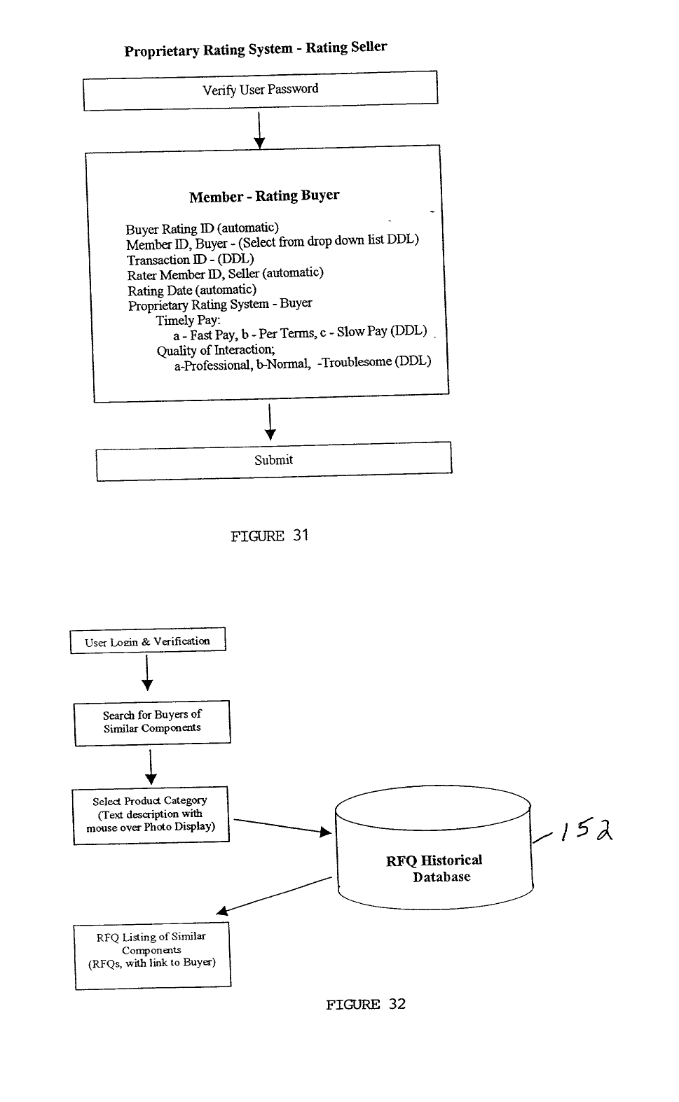

As illustrated in FIGS. 30 and 31, Buyers and Sellers are encouraged to rate each other at the conclusion of each transaction. Buyers are rated as to Quick Pay, Slow Pay, Pay per Terms, and Quality of Experience. Sellers are rated as to Quality, Delivery, Landed Price, and Quality of Experience.

The Buyer can select “Best Value” Weighting Criteria for:

Quality Rating

Delivery Rating

Landed Price Rating

Quality of Experience Rating

Best Value is used to rank seller quotations. Rankings include:

Pricing Only

Seller Country, and Price Only

Seller Country, and Best Value Rating

Best Value Rating

Quality Rating

Delivery Rating

Landed Price Rating

Quality of Experience Rating

Seller can view the Buyer “Best Value” Criteria during the bid process.

The historical transaction database provides detailed information on:

World Trade

Shifts in Purchasing Trends

Global Manufacturing

Worldwide Pricing

Activity & Capabilities

Purchasing Data by:

Country: Day, Week, Month, Year

Industry: Day, Week, Month, Year

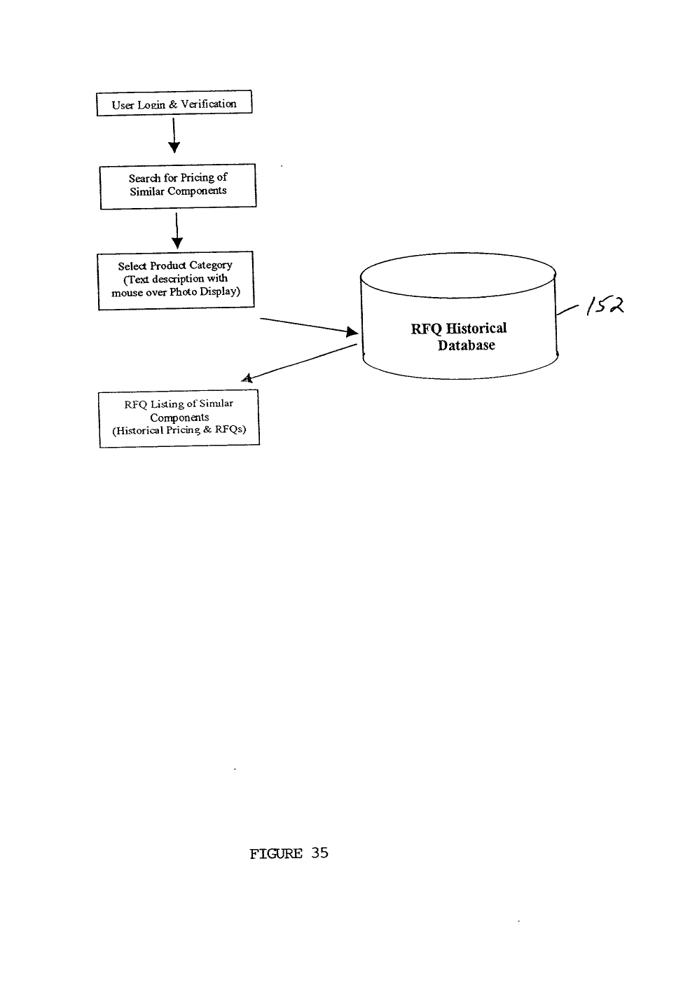

FIG. 32 is a flow chart illustrating use of the RFQ Historical Database 152 by Sellers for locating Buyers of similar components. The RFQ Historical Database 152 can also be used by Buyers to locate Sellers of similar components as shown in FIG. 34.

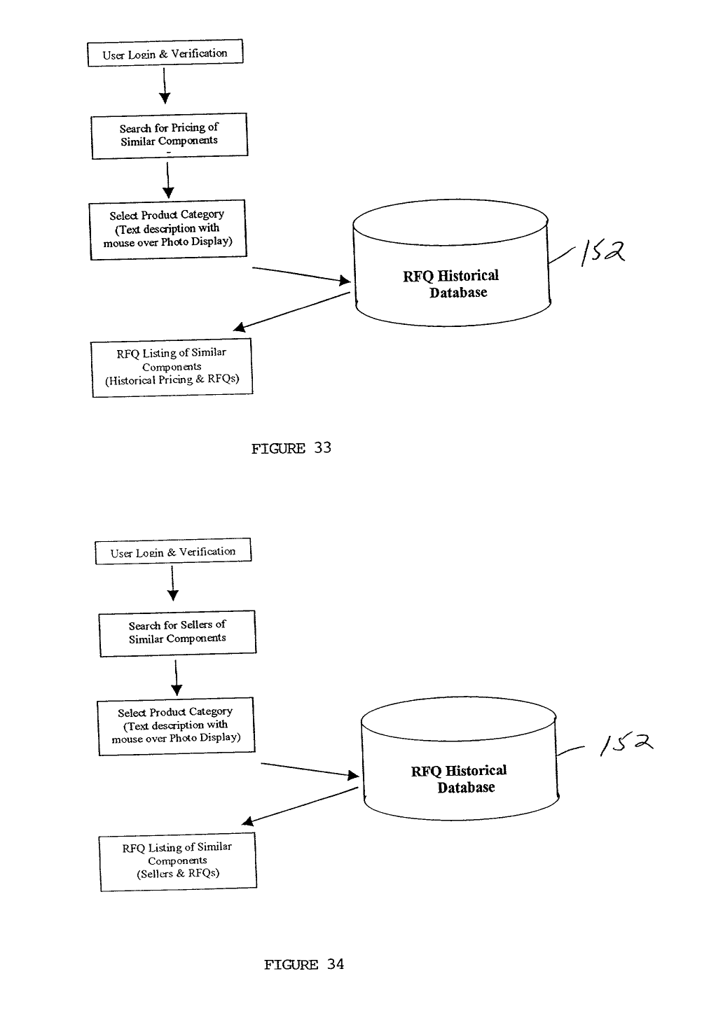

Both Sellers and Buyers can advantageously use the RFQ Historical Database for reviewing global historical pricing for similar components. See FIGS. 33 and 35.

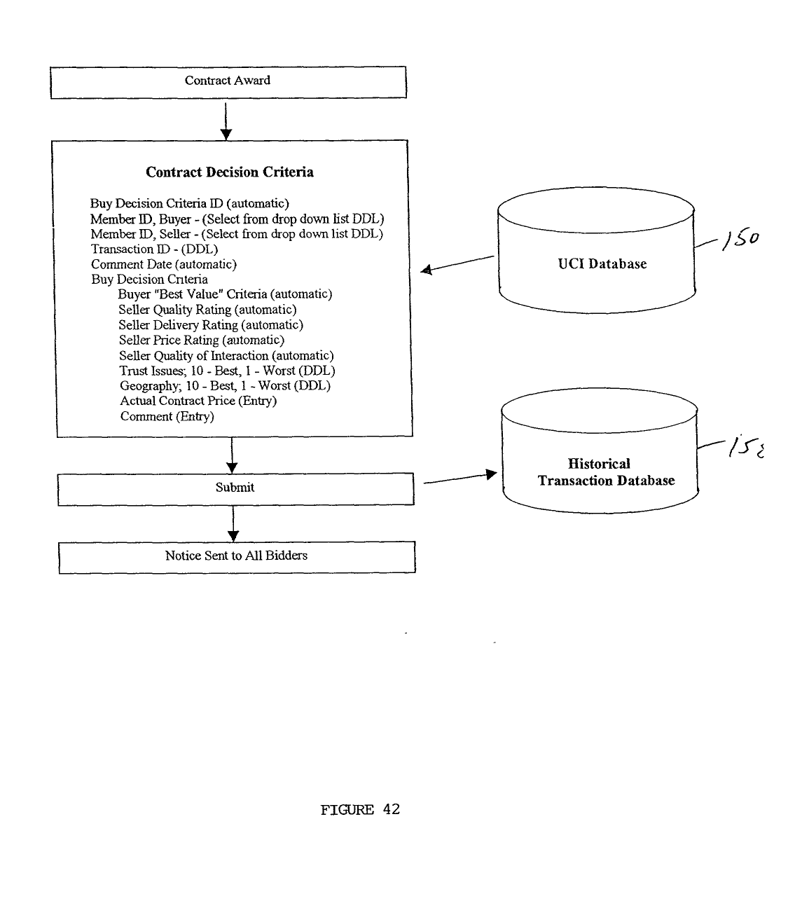

Another feature of this invention is that it assists its member Sellers to compete in the global economy. Thus, unsuccessful Sellers who have bid on RFQs are subsequently notified with certain information relating to the contract award decision as illustrated by the flow chart of FIG. 42. Advantageously, member Sellers are notified by e-mail and a record is available at the system web site indicating the factors influencing the Buyer's decision listed in FIG. 42, including quality, delivery, price and geography.

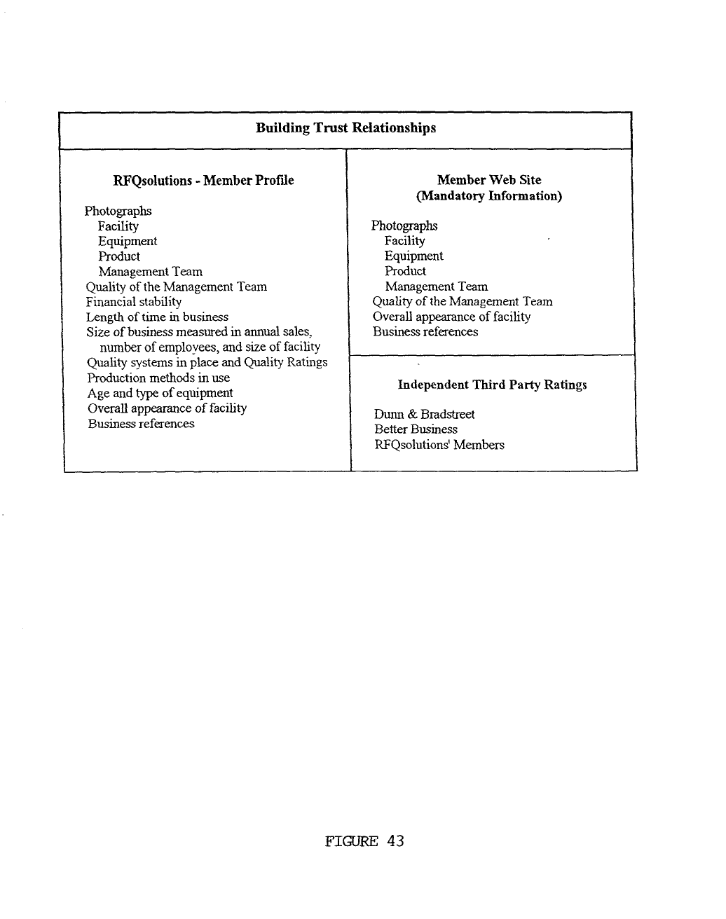

Another advantage of the invention is that it promotes building trust relationships between Buyers and Sellers. Thus, as illustrated in FIG. 43, the system provides very detailed information about its membership. Advantageously, the Member Profile provides a standardized view of each member company, with links to the member's Web site and quality rating.

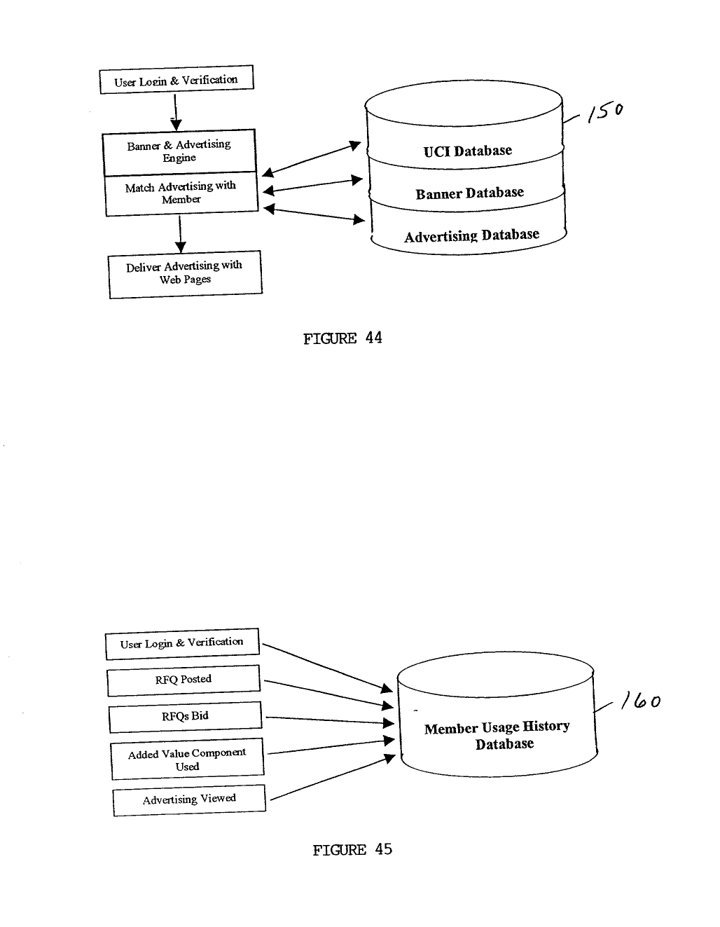

An additional feature of this invention, illustrated by the flow chart of FIG. 44, is that the UCI Database 150 enables the member company to provide advertising to only those members who meet very specific criteria. By way of specific example, in the case of a machine shop, the system can limit advertising to only those member companies that have a certain type and model of equipment.

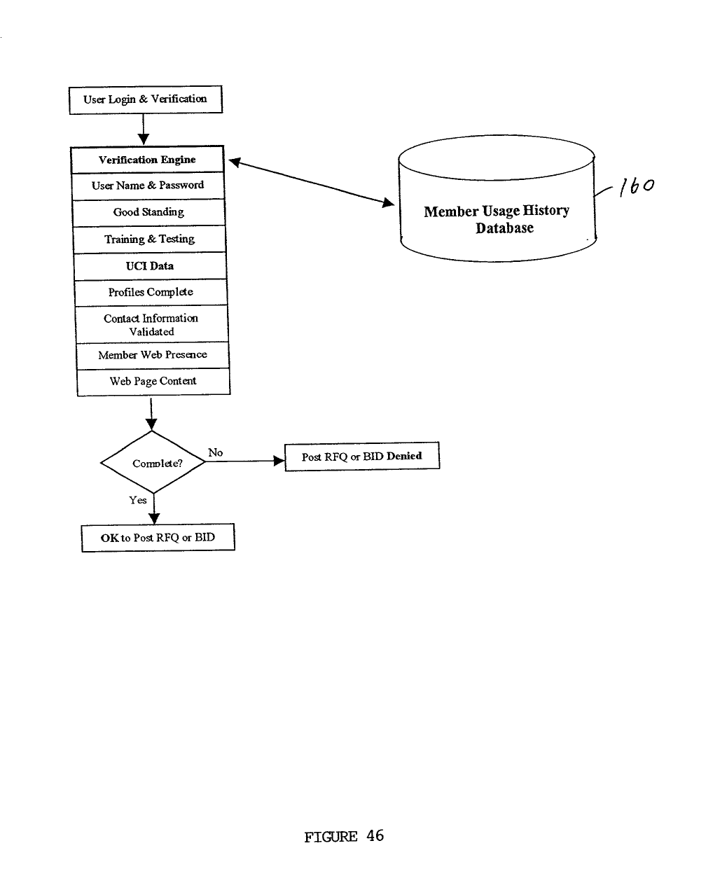

Referring to the flow chart shown in FIG. 45, the system advantageously includes a Member Usage History Database 160 to track member usage including:

Track number of days logged on

Track number of RFQs posted

Track number of RFQs Bid

Track use of added value components

Track types of advertising viewed

Such usage history may be used in further marketing efforts and for tracking system effectiveness and development of new features.

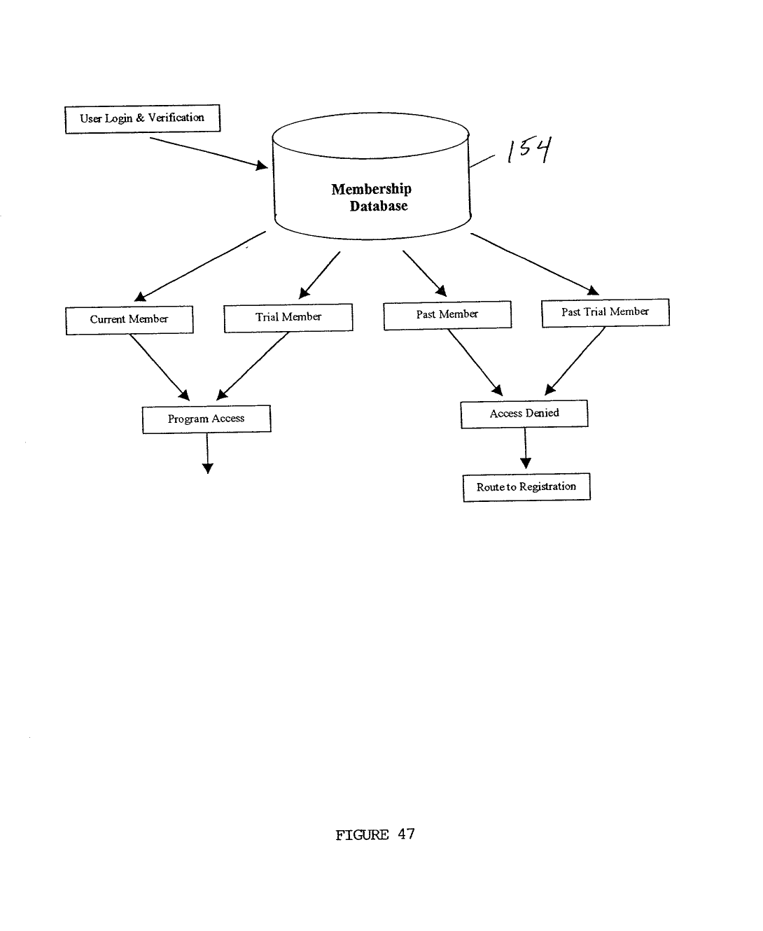

The preferred embodiments of the invention advantageously require that certain member data must be verified before the Buyer is allowed to post an RFQ or a Seller is allowed to bid. The flow chart of FIG. 46 illustrates a preferred system for making this check automatically.

The flow chart of FIG. 47 illustrates a system for tracking all current members, past members as well as past members who participated in a trial membership program. This information is stored in the membership database 154. This system allows for providing access on a free or a lower fee basis for an initial trial basis and also precludes a member from continuously trying the system on a trial basis.

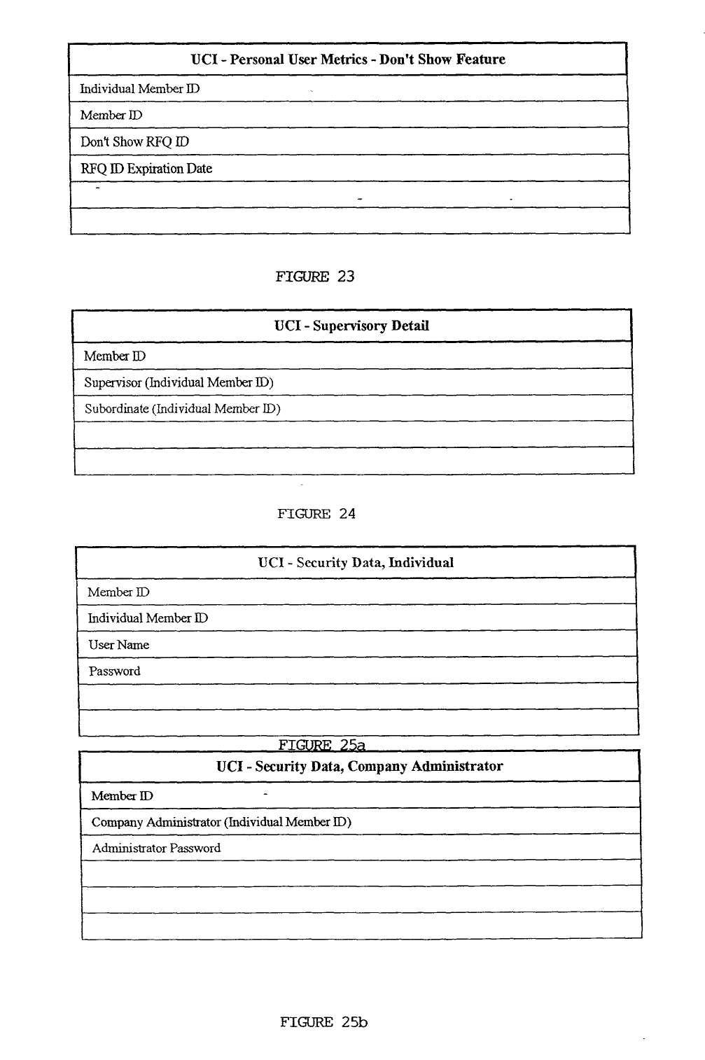

The “Don't Show Feature” of FIG. 23 is used to minimize data presented to the user each time he/she views “Available RFQs.” A “Don't Show this RFQ Again”0 check box is displayed with each “available RFQ.” The system database stores this information so that the next time the user views “Available RFQs,” all RFQs with the “Don't Show” Feature checked will not be shown. This feature significantly reduces visual clutter for the user.

Chat Rooms are advantageously made available to share technical information and provide access to industry experts for problem solving.

Advantageously, the system automatically tracks the member's profile so that if a profile hasn't been updated in a predetermined passage of time, the member is contacted.

Representative industries that will benefit from this invention include:

Aerospace/Aircraft

Agricultural

Appliance

Automation

Automotive (OEM)

Automotive (Tier I)

Business Mach./Equip.

Chemical

Computer

Construction

Consumer Electronics

Consumer Packaged Goods

Consumer Products

Contract Manufacturing

Controls

Durable Goods

Electronic/Electric

Energy

Engineering

Exploration/Production

Fabricated Metal Industry

Food

General Retail

Hydraulic/Pneumatic

Industrial Systems/Controls

Industrial/Commercial

Machinery/Equipment

Instrumental

(Measure/Control/Test/Analyze)

Lighting

Manufacturing/Industrial

Medical Equipment

Medical/Healthcare

Metals

Military/Defense

Mining Equipment

Mold Makers

Nuclear

OEM

Optical Components

Packaging

Paper/Paperboard

Petroleum

Plastics

Power Generation

Primary Metal Industry

Recreational +

Semiconductor

Service

Telecommunications

Textile

Tool & Die

Transportation Equipment

Utilities

Wood/Furniture

Representative specific markets that will benefit from this invention include:

Precision Machined Products

Manufacturers (Primary Function—Buyer)

Machinery Manufacturers

Machine Tool Manufacturers

Steel Manufacturers

Tubular Manufacturers

Valve Manufacturers

Fastener Manufacturers

Aerospace Manufacturers

Machinery & Equipment Manufacturers

Implement Manufacturers

Builders Hardware Manufacturers

Loading & Elevating Equipment Manufacturers

Power Generating Equipment Manufacturers

Machine Tool Manufacturers

Equipment Manufacturers (agricultural, construction, forestry, materials handling & utility equipment)

Valves & Actuators Manufacturers

Safety Equipment Manufacturers

Builders Hardware Manufacturers

Agricultural Equipment Manufacturers

Barbecue Manufacturers

Marine Equipment Manufacturers

Can Manufacturers

Cleaning Equipment Manufacturers

Home Appliance Manufacturers

Office Furniture Manufacturers

Health Industry Manufacturers

Manufacturers of Emission Controls

Primary Metal Industries

Fabricated Metal Products

Industrial & Commercial Machinery Manufacturers

Transportation Equipment Manufacturers

Air & Gas Compressor Manufacturers

General Purpose Machinery manufacturing

Machine Tool Accessory Manufacturing

Fluid Power Cylinder and Actuator Manufacturing

Fluid Power Pump & Motor Manufacturing

Fluid Power Valve & Hose Fitting Manufacturing

Industrial Pattern Manufacturing

Industrial Truck, Tractor, Trailer and Stacker Machinery Manufacturing

Industrial Valve Manufacturing

Marking Device Manufacturing

Measuring and Dispensing Pump Manufacturing

Pump Manufacturing

Oil & Gas Field machinery and Equipment Manufacturing

Valve & Pipe Fitting Manufacturing

Metal Working Machinery Manufacturing

Packaging Machinery Manufacturing

Plastics & Rubber Industry Machinery Manufacturing

Paper Industry Machinery Manufacturing

Printing Machinery & Equipment Manufacturing

Pump & Pumping Equipment Manufacturing

Sawmill & Woodworking Machinery Manufacturing

Scale & Balance Manufacturing

Die & Tool, Die Set, Jig, and Fixture Manufacturing

Spring Manufacturing

Textile Machinery Manufacturing

Transportation Equipment Manufacturing

Construction Equipment Manufacturing

Hardware Manufacturing

Mechanical Power Transmission Equipment Manufacturing

Mining Machinery & Equipment Manufacturing

Motor & Generator Manufacturing

Semiconductor machinery Equipment Manufacturing

Institutional Furniture Manufacturing

Precision Machined Products (Continued)

Manufacturers (Primary Function—Seller/Buyer)

Precision Manufacturing

Gear Manufacturers

Metal Forming

Fluid Power

Metal Stamping

Metal Fabricators

Machined Products

Tooling and Machining

Metal Fabrications

Precision Machined Products

Precision Metal Forming

Tooling & Manufacturing

Paint and Coatings

Metal Finishing

Metal Working

Precision Machining

Honing

Water Cut Equipment

General Machining

Fabricators

Sheet Metal Fabricators

Stamping

Fine Blanking

Rolled Steel Products

Screw Machine Shops

Notching Equipment

Thread Rolling

Heading

Cold Forging

Inspection Services

Heat Treat; Conditioning

Tool & Die

Tool & Die

EDM Shops

Injection Molds

Mold Builders

Abrasive Machining

O.D. Grinding

I.D. Grinding

Centerless Grinding

Jig Grinding

Lapping

Primary Materials

Foundries

Metal Casting

Die Casting

Rotational Molders

Sintered Metal Manufacturers

Powder Metallurgy Part Manufacturing

Forging

Cast Metals

Investment Casting

Metal Casting

Sand Casting

Extrusion

What is claimed is:

1. The method of providing an efficient worldwide sourcing services comprising:
storing a comprehensive database for manufacturing companies worldwide including their sales volumes, process capability and markets serviced;
receiving a request for quote (RFQ) which includes the buyer's requirements for the seller, contract specifications and drawings and specifications of the component to be manufactured;
automatically selecting from said database those sellers having the specific capability to manufacture said component;
automatically transmitting said list of potential sellers to said buyer of said component for buyer's selection and deselecting said sellers;
enabling the selected sellers to review online all open RFQ's and enter bids; and
storing historical transactions between buyers and sellers including RFQ's from buyers and bids from sellers.

2. The method of claim 1, including receiving from buyers their ratings about sellers and receiving from sellers their ratings about buyers of buyers.

3. The method of claim 2, wherein buyers are rated by sellers as to Quick Pay, Show Pay, Pay Per Terms and Quality of Experience.

4. The method of claim 2, wherein sellers are rated by buyers as to Quality, Delivery/Landed Price and Quality of Experience.

5. The method of claim 1, including online locating of buyers of similar components.

6. The method of claim 1, including online location of sellers of similar components.

7. The method of claim 1, comprising transmitting to unsuccessful bidders information about the buyer's decision including quality, delivery, price and geography.

8. The method of claim 1, wherein said buyer's request for quote (RFQ) includes photographs of the component to be manufactured.

9. The method of providing an efficient worldwide sourcing services comprising:
storing a comprehensive database for manufacturing companies worldwide including their sales volumes, process capability and markets serviced;
receiving a request for quote (RFQ) which includes the buyer's requirements for the seller, contract specifications and drawings and specifications of the component to be manufactured;
automatically selecting from said database those sellers having the specific capability to manufacture said component;
automatically transmitting said list of potential sellers to said buyer of said component for buyer's selection and deselecting said sellers;
enabling the selected sellers to review online all open RFQ's and enter bids; and
transmitting to unsuccessful bidders information influencing the buyer's decision including quality, delivery, price and geography.

10. The method of providing an efficient worldwide sourcing services comprising:
storing a comprehensive database for manufacturing companies worldwide;
receiving requests for quote which include the Buyer's requirement criteria for the seller;
automatically selecting from said database those sellers matching the buyer's requirement criteria;
sending said list of potential sellers to said buyers of said component for buyer's selection and deselecting said sellers; and
enabling the selected sellers to review online all open RFQ's.

11. A system for automated sourcing comprising:
a database storing detailed information about a plurality of manufacturing sellers;
a server computer connected to the World Wide Web storing a buyer's RFQ including a description of the component to be manufactured, said server limiting online access to said description to only automatically selected sellers; and
a computer coupled to said database and said server computer comparing the seller's capabilities with a buyer's RFQ criteria.
